(19) United States
(12) Patent Application Publication
(10) Pub. No.: US 2022/0341467 A1
(43) Pub. Date: Oct. 27, 2022

(54) BEARING WITH INTEGRATED AXIAL PRELOAD AND METHOD THEREOF

(71) Applicant: Schaeffler Technologies AG & Co. KG, Herzogenaurach (DE)

(72) Inventors: Guihui Zhong, Charlotte, NC (US); Daniel Wuerdinger, Troy, MI (US); Michael Heaton, Rock Hill, SC (US); Dennis Roffe, Fort Mill, SC (US); James Brown, Rock Hill, SC (US)

(73) Assignee: Schaeffler Technologies AG & Co. KG, Herzogenaurach (DE)

(21) Appl. No.: 17/238,292

(22) Filed: Apr. 23, 2021

(51) Int. Cl. F16C 33/78; F16C 33/32; F16C 19/06

(52) U.S. Cl. CPC F16C 33/784; F16C 33/32; F16C 19/06

(57) ABSTRACT

A bearing, including: an inner ring defining a first groove; an outer ring including a radially inner surface, the radially inner surface facing an axis of rotation of the bearing, defining a second groove, and defining at least one third groove; a cage radially disposed between the inner ring and the outer ring; a plurality of balls retained by the cage, and disposed in the first groove, and in the second groove; an annular sleeve including a first portion disposed in the third groove; and a resilient element urging the outer ring and the annular sleeve away from each other parallel to the axis of rotation of the bearing.

### TECHNICAL FIELD

The present disclosure relates to a bearing with integrated axial preloading to prevent noise and vibration associated with changes in rotational torque, rotational direction, and/or axial loading associated with operation of the bearing.

### BACKGROUND

Changes in rotational torque, rotational direction, and/or axial loading associated with operation of known bearings causes undesirable noise and vibration. To address the noise and vibration problem, it is known to perform additional steps, such as shimming, when the bearing is installed in an assembly, which increases the cost and complexity of using the bearing.

### SUMMARY

According to aspects illustrated herein, there is provided a bearing, including: an inner ring defining a first groove; an outer ring including a radially inner surface, the radially inner surface facing an axis of rotation of the bearing, defining a second groove, and defining at least one third groove; a cage radially disposed between the inner ring and the outer ring; a plurality of balls retained by the cage, and disposed in the first groove, and in the second groove; an annular sleeve including a first portion disposed in the third groove; and a resilient element urging the outer ring and the annular sleeve away from each other parallel to the axis of rotation of the bearing.

According to aspects illustrated herein, there is provided a bearing, including: an inner ring defining a first circumferentially continuous groove; an outer ring including a radially inner surface, the radially inner surface defining a second circumferentially continuous groove and defining at least one circumferentially oriented groove; a cage radially disposed between the inner ring and the outer ring; a plurality of balls retained by the cage and disposed in the first circumferentially continuous groove, and in the second circumferentially continuous groove; an annular sleeve including at least one radially outwardly extending tab, the at least one radially outwardly extending tab including a distal end disposed in the at least one circumferentially oriented groove; and a resilient element in contact with the annular sleeve and the outer ring and urging the outer ring and the annular sleeve away from each other parallel to an axis of rotation of the bearing. A maximum extent of the at least one circumferentially oriented groove in an axial direction, parallel to the axis of rotation, is at least twice a maximum extent of the at least one radially outwardly extending tab in the axial direction.

According to aspects illustrated herein, there is provided a method of operating a bearing assembly, the bearing assembly including a housing, a bearing enclosed by the housing, the bearing including an inner ring defining a first groove, an outer ring connected to the housing and including a radially inner surface defining a second groove and a circumferentially oriented groove, a cage radially disposed between the inner ring and the outer ring, a plurality of balls retained by the cage and disposed in the first groove and in the second groove, a ring-shaped sleeve with a tab disposed in the circumferentially oriented groove, and a resilient element in contact with the ring-shaped sleeve and the outer ring, and a shaft connected to the inner ring. The method comprises: urging, with the resilient element, the ring-shaped sleeve into contact with a surface of the housing facing in a first axial direction parallel to an axis of rotation of the bearing; urging, with the resilient element and with a first force, the outer ring in the first axial direction, with respect to the housing, and into contact with the plurality of balls; rotating the shaft and the inner ring with respect to the housing, in a circumferential direction around the axis of rotation of the bearing; and displacing, with a second force, less than the first force, the outer ring in the first axial direction, maintaining, with the resilient element, a contact of the ring-shaped sleeve with the surface of the housing, and maintaining, with the resilient element, a contact of the outer ring with the plurality of balls, or displacing, with a second force, less than the first force, the outer ring in a second axial direction opposite the first axial direction, maintaining, with the resilient element, a contact of the ring-shaped sleeve with the surface of the housing, and maintaining, with the resilient element, a contact of the outer ring with the plurality of balls.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front view of a bearing with an integrated axial preload and continuous groove;

FIG. 2 is an exploded view of the bearing shown in FIG. 1;

FIG. 3 is a cross-sectional view generally along line 3/8-3/8 in FIG. 1;

FIG. 4 is a detail of FIG. 3;

FIG. 5 is a cross-sectional view of a bearing assembly including the bearing shown in FIG. 1, with the bearing in an initial preloaded state;

FIG. 6 is a cross-sectional view of the bearing assembly shown in FIG. 5 with a resilient element in a fully expanded state;

FIG. 7 is a cross-sectional view of the bearing assembly shown in FIG. 5 with the resilient element in partially compressed state;

FIG. 8 is a cross-sectional view generally along line 3/8-3/8 in FIG. 1;

FIG. 9 is an exploded view of the bearing shown in FIG. 8; and

FIG. 10 illustrates a variation of tabs of the bearing shown in FIGS. 1 and 8.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices, or materials similar or equivalent to those described herein can be used in the practice or testing of the disclosure.

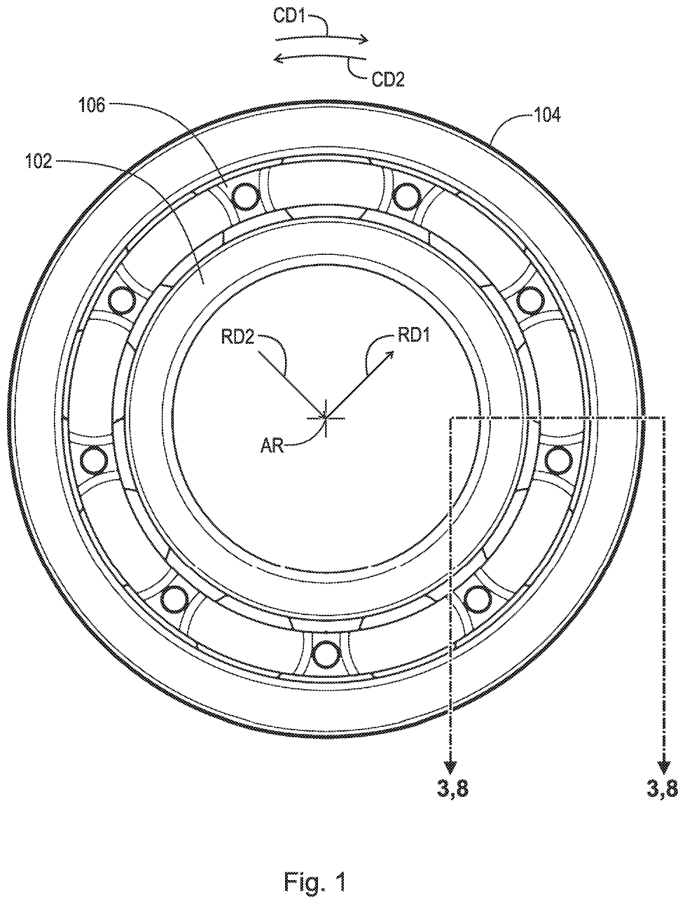

FIG. 1 is a front view of bearing 100 with an integrated axial preload and a continuous groove.

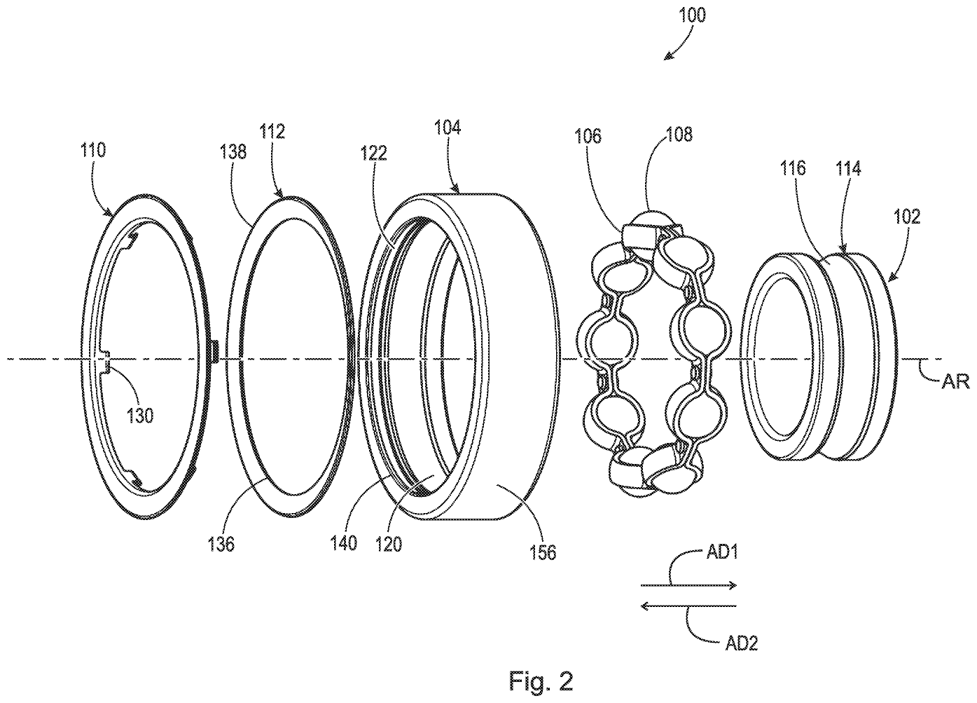

FIG. 2 is an exploded view of bearing 100 shown in FIG. 1. The following should be viewed in light of FIGS. 1 and 2. Example bearing 100 includes: inner ring 102; outer ring 104 located radially outward of ring 102; cage 106 radially disposed between inner ring 102 and outer ring 104; balls 108 retained by cage 106; annular, or alternately stated, ring-shaped, sleeve 110; and resilient element 112. Inner ring 102 includes radially outer surface 114, facing away from axis of rotation AR of bearing 100 in radially outer direction RD1 orthogonal to axis AR. In the example of FIG. 1, resilient element 112 is a disc spring. However, it is understood that resilient element 112 is not limited to a disc spring and that other resilient element configurations are possible.

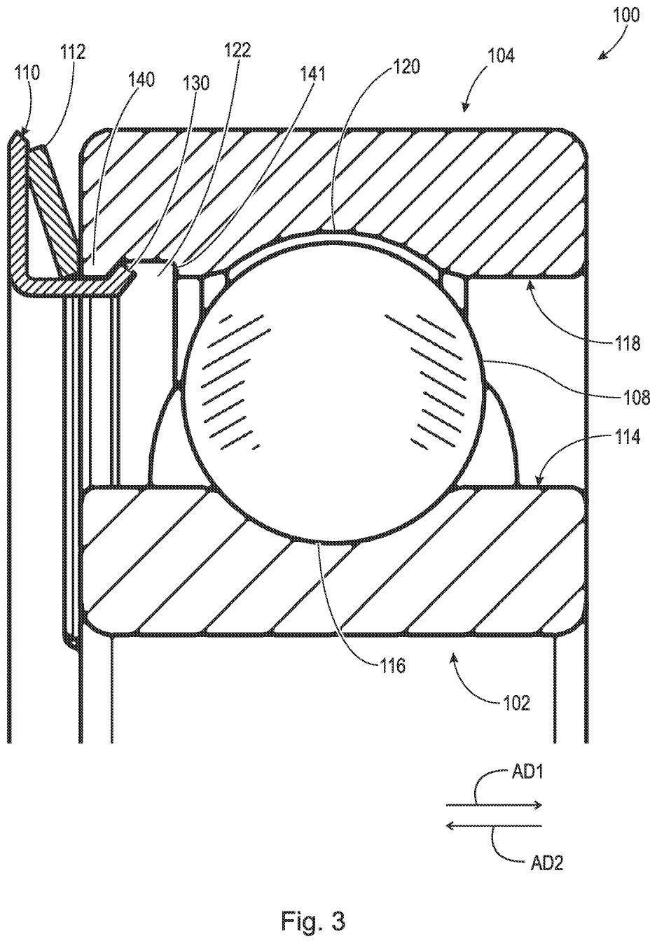

FIG. 3 is a cross-sectional view generally along line 3/8-3/8 in FIG. 1. The following should be viewed in light of FIGS. 1 through 3, Surface 114 defines circumferentially continuous groove 116. By a “circumferentially continuous” feature, we mean the feature is continuous or unbroken for 360 degrees in circumferential direction CD1 around axis AR. Outer ring 104 includes radially inner surface 118. Surface 118: faces axis of rotation AR in radially inner direction RD2, opposite direction RD1; and defines circumferentially continuous groove 120 and circumferentially continuous groove 122. Balls 108 are disposed in grooves 116 and 120. In the example of FIG. 1, sleeve 110 and resilient element 112 are each circumferentially continuous.

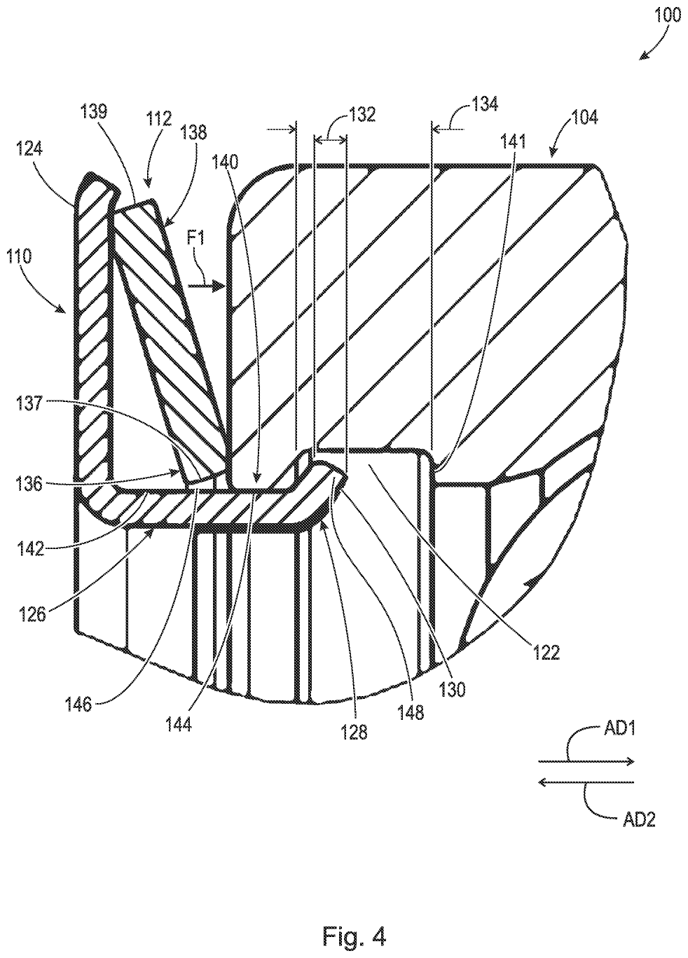

FIG. 4 is a detail of FIG. 3. The following should be viewed in light of FIGS. 1 through 4. Sleeve 110 includes: portion 124 substantially orthogonal to axis AR; portion 126 extending from portion 124 substantially in axial direction AD1 parallel to axis AR; and portion 128 extending from portion 126 and into groove 122, In the example of FIG. 1, portion 128 includes radially outwardly extending tabs 130. Resilient element 112 is preloaded to urge outer ring 104 and portion 124 away from each other parallel to axis AR. For example, resilient element 112 urges: outer ring 104 in direction AD1; and sleeve 110 in direction AD2, opposite direction AD1. In the example of FIG. 1, tabs 130 are formed by bending distal ends of respective portions 128.

Tabs 130 have maximum axial extent 132 in direction AD1. Groove 122 has maximum axial extent 134 in direction AD1. In the example of FIG. 1, extent 134 is greater than extent 132. In the example of FIG. 1, extent 134 is at least twice extent 132. In the example of FIG. 1, resilient element 112 includes radially inner portion 136, including end 137, in contact with outer ring 104, and radially outer portion 138, including end 139, in contact with sleeve 110.

Outer ring 104 includes circumferentially continuous lip 140. Lip 140 defines groove 122 in direction AD2. Outer ring 104 includes surface 141 defining groove 122 in direction AD1. Resilient element 112 urges tabs 130 and lip 140 into contact. In the example of FIG. 1: no portion of sleeve 110 extends radially outward in direction RD1 past outer ring 104; and no portion of resilient element 112 extends radially outward in direction RD1 past outer ring 104. Portion 126 includes radially outwardly facing surface 142, and lip 140 includes radially inwardly facing surface 144. In the example of FIG. 1, end 137 of resilient element 112 and surface 142 define gap 146 in direction RD1. Gap 146 enables flow of lubricant through bearing 100. In the example of FIG. 1, surface 144 is a pilot surface and surface 142 is in contact with surface 144 to pilot and center sleeve 110.

As noted above, operation of known bearings can result in undesirable noise and vibration. One source of this noise and vibration in known bearings is collisions between balls and rings of the bearing caused by a change of direction of torque applied to the bearing and/or by an axial load applied to the bearing. In particular, the relative axial positions of balls and rings of the bearing are not fixed, such that the change in torque direction and/or the axial load cause shifting of the balls and/or the rings with respect to each other, resulting in collisions between the balls and rings and subsequent noise and vibration. Bearing 100 resolves this problem by holding balls 108 and rings 102 and 104 in contact. In particular, inner portion 136 of resilient element urges outer ring 104 in direction AD1 to bring balls 108 into contact with inner ring 102 and outer ring 104, and to maintain that contact, thus preventing relative displacement between balls 108 and inner ring 102 and outer ring 104.

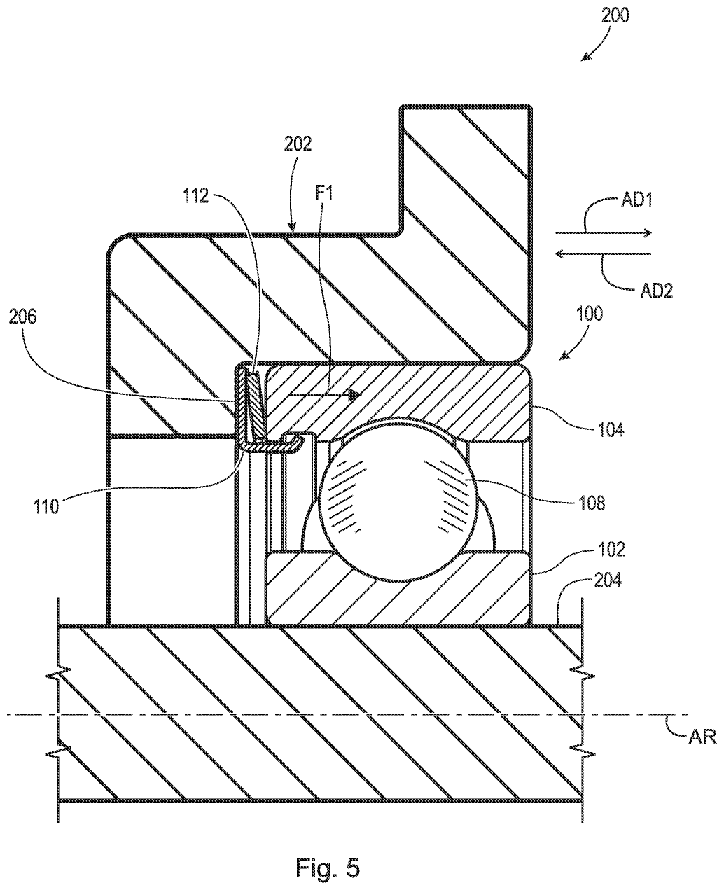

FIG. 5 is a cross-sectional view of bearing assembly 200 including bearing 100 shown in FIG. 1, with bearing 100 in an initial preloaded position. Bearing assembly 200 includes housing 202 and shaft 204 non-rotatably connected to inner ring 102. Bearing 100 is at least partially installed in and enclosed by housing 202. Outer ring 104 is connected to housing 202. Shaft 204 is arranged to receive rotational torque in one or both of circumferential CD1 and circumferential direction CD2, opposite direction CD1. In FIG. 5, shaft 204 is not rotating and is free of an axial load. As discussed below, from the preloaded position shown in FIG. 5, bearing 100 is able to respond to an axial load on shaft 204 in direction AD1 and to an axial load on shaft 204 in direction AD2.

Outer portion 138 of preloaded resilient element 112 urges sleeve 110 in direction AD2 to hold portion 124 of resilient element 112 in constant contact, under all axial loading conditions, with surface 206 of housing 202 facing direction AD1. Resilient element 112 reacts against surface 206 and portion 124 to urge outer ring 104 in direction AD1 with force F1 to hold rings 102 and 104 in contact with balls 108. As noted above, holding rings 102 and 104 in contact with balls 108 prevents collisions between balls 108 and rings 102 and 104 caused by axial loading of bearing 100, The axial loading can come from a change in rotational torque on shaft 204, a change of direction of rotational torque on shaft 204, and/or a change of an existing axial load on shaft 204, for example shifting a gear that is rotating shaft 204.

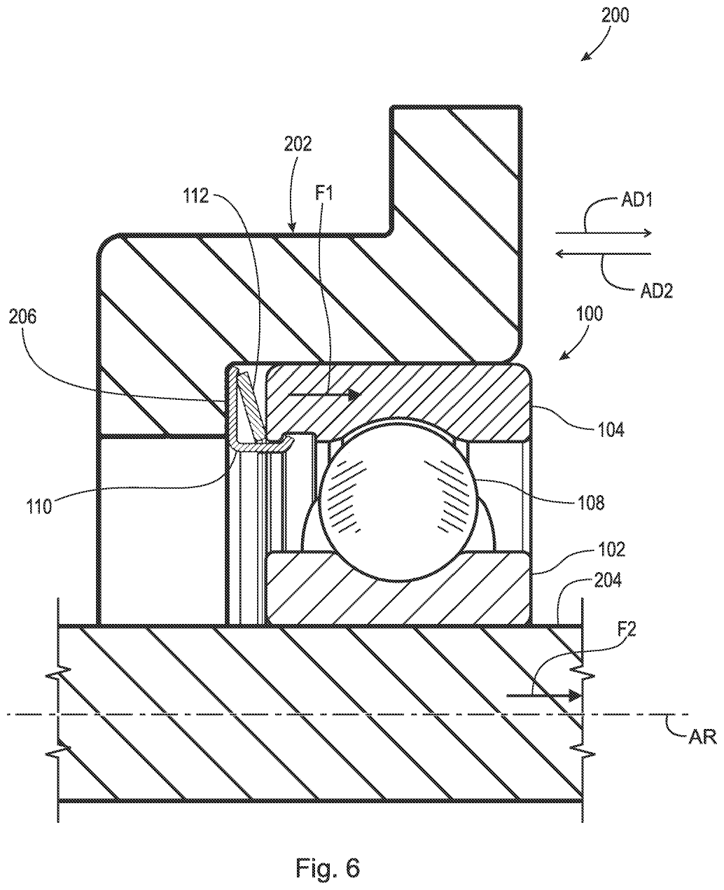

FIG. 6 is a cross-sectional view of bearing assembly 200 shown in FIG. 5 with resilient element 112 in a fully expanded state. In the example of FIG. 5: an axial load with force F2, less than force F1, is applied to shaft 204 and bearing 100 in direction AD1. As ring 104 shifts in direction AD1 in response to force F2, resilient element 112 continues to urge ring 104 in direction AD1, maintaining contact of rings 102 and 104 with balls 108.

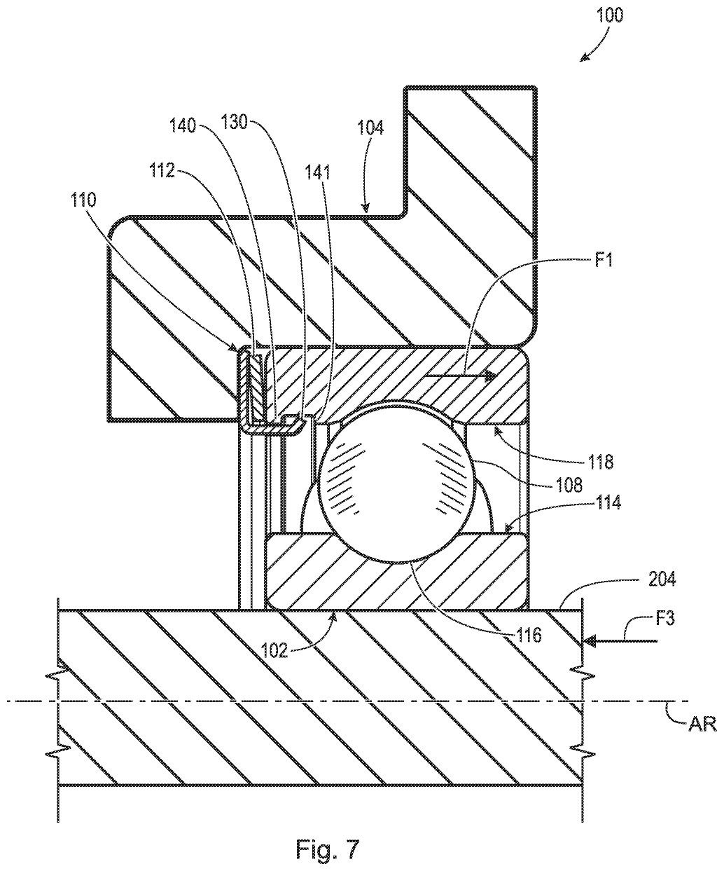

FIG. 7 is a cross-sectional view of bearing assembly 200 shown in FIG. 5 with resilient element 112 in a partially compressed state. A second source of noise and vibration in known bearings is the collision of one of the rings of the bearing with a housing, in which the bearing is installed in response to an axial load on the bearing. Bearing 100 prevents such collisions. In the example of FIG. 7, an axial load with force F3, less than force F1, is applied to shaft 204 and bearing 100 in direction AD2. Force F3 shifts ring 104 in direction AD2 to less than fully compress resilient element 112. Resilient element 112 continues to urge ring 104 in direction AD1, maintaining contact of rings 102 and 104 with balls 108. Since resilient element 112 is less than fully compressed: outer ring 104 and resilient element 112 do not collide with sleeve 110 and housing 202. In the example of FIG. 7: force F3 is at its maximum magnitude; resilient element 112 is in its maximum compressed state; and tabs 130 are free of contact with surface 141, preventing possible damage to groove 120 from contact of tabs 130 with surface 141.

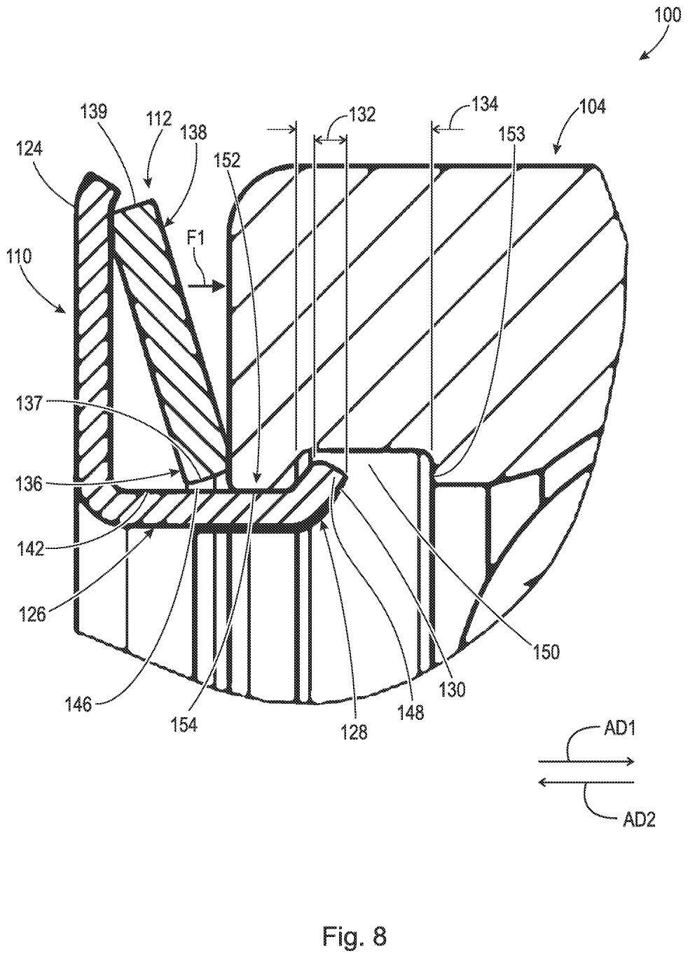

FIG. 8 is a cross-sectional view generally along line 3/8-3/8 in FIG. 1.

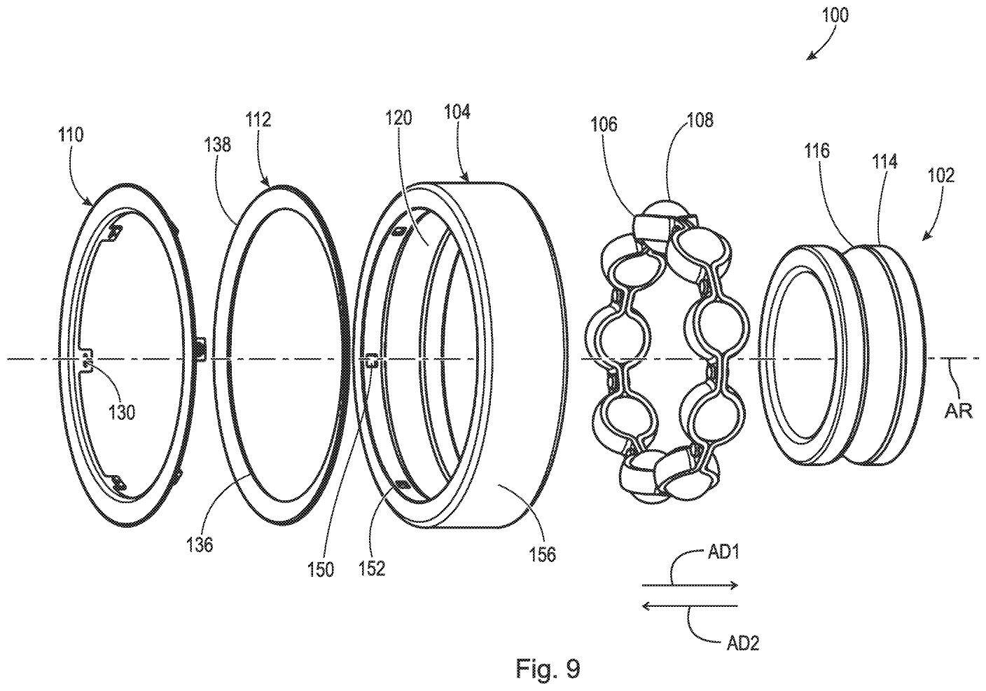

FIG. 9 is an exploded view of bearing 100 shown in FIG. 8.

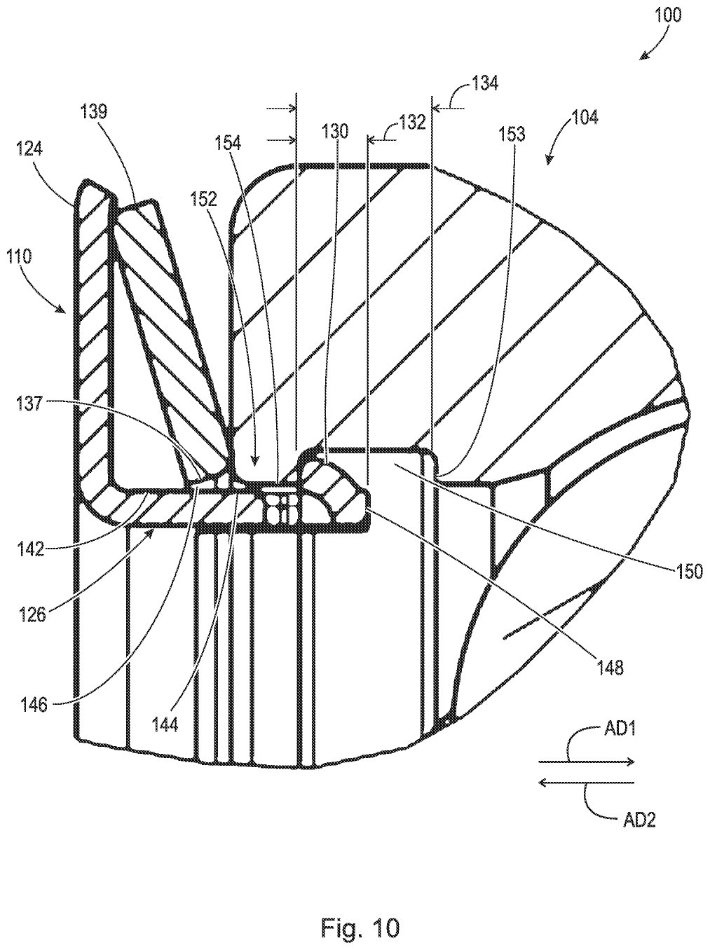

FIG. 10 illustrates a variation of tabs 130 of bearing 100 shown in FIGS. 1 and 8. The discussion for FIGS. 1 through 4 is applicable to FIGS. 8 through 10 except as noted. In FIG. 8: multiple circumferentially discontinuous grooves 150 replace single circumferentially continuous groove 122 in outer ring 104; multiple circumferentially discontinuous lips 152 replace single circumferentially continuous lip 140; and multiple surfaces 153 replace single surface 141. Lips 152 bound grooves 150 in direction AD2. Surfaces 153 define grooves 150 in direction AD1. Lips 152 are more resistant to distortion in direction AD2, from contact with tabs 130, than lip 140.

Lips 152 include radially inwardly facing surfaces 154. In the example of FIG. 8, surfaces 154 are pilot surfaces and surface 142 is in contact with surfaces 154 to pilot and center sleeve 110.

The following should be viewed in light of FIGS. 1 through 10. The following describes a method of preloading bearing assembly 200. Although the method is presented as a sequence of steps for clarity, no order should be inferred from the sequence unless explicitly stated. A first step urges, with resilient element 112, sleeve 110 into contact with surface 206 of housing 202. A second step urges, with resilient element 112 and with force F1, outer ring 104 in axial direction AD1 with respect to housing 202 and into contact balls 108. A third step rotates shaft 204, with respect to the housing 202, in circumferential direction CD1 or circumferential direction CD2. A fourth step: displaces, with force F2, less than the force F1, outer ring 104 in axial direction AD1, maintains, with resilient element 112, contact of sleeve 110 with surface 206, and maintains, with resilient element 112, contact of outer ring 104 with balls 108; or, displaces, with force F3, less than force F1, outer ring 104 in axial direction AD2, maintains, with resilient element 112, contact of sleeve 110 with surface 206, and maintains, with resilient element 112, contact of outer ring 104 with balls 108.

Displacing, with force F2, outer ring 104 in axial direction AD1 includes: fully expanding resilient element 112, and avoiding contact of tab 130 with surface 141 of outer ring 104; or fully expanding resilient element 112, and avoiding contact of tab 130 with surfaces 153 of outer ring 104. Displacing, with force F3, outer ring 104 in axial direction AD2 includes less than fully compressing resilient element 112.

Example bearing 100 is a deep groove ball bearing. However, it is understood that bearing 100 is not limited to a deep groove ball bearing and that other bearing configurations are possible for bearing 100 including, but not limited to: a cylindrical roller bearing; a tapered roller bearing; a needle roller bearing; and an angular contact ball bearing.

Bearing 100 and a method of using bearing 100 provide at least the following advantages:
1. Elimination or minimization of noise and vibration associated with operation of bearing 100.
2. Integrated preloading. No external components or steps, such as shim g, to address noise and vibration, are needed as part of installing bearing 100.
3. Grooves 122 and 150 are in inner radial surface 114 of outer ring 104, not in radially outer load bearing surface 156 of outer ring 104. Thus, the durability and service life of bearing 100 are maximized.
4. Sleeve 110 can be made of steel with a cost-effective stamping and/or bending process, reducing cost and complexity of fabricating sleeve 110, while optimizing the durability of sleeve 110.
5. In general, a housing for a bearing is made of aluminum or other metal softer than the metal, such as steel, used to fabricate sleeve 110 and resilient element 112. Portion 124 of sleeve 110 shields housing 202 from contact with resilient element 112, eliminating wear on housing 202 from resilient element 112.
6. The stiffness of resilient element 112, and hence the magnitude of force F1, can be tuned to match the load requirements of the intended application and provide optimal dampening.
7. Extent 134 of grooves 122 and 150 can be selected to accommodate the expected amount of axial displacement of bearing 100 under axial load.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

AD1 axial direction
AD2 axial direction
AL axial load
AR axis of rotation
CD1 circumferential direction
CD2 circumferential direction
F1 preload force, resilient element
RD1 radially outer direction
RD2 radially inner direction
100 bearing
102 inner ring
104 outer ring
106 cage
108 ball
110 sleeve
112 resilient element
114 radially outer surface, inner ring
116 groove, inner ring
118 radially inner surface, outer ring
120 groove, outer ring
122 groove, outer ring
124 portion, sleeve
126 portion, sleeve
128 portion, sleeve
130 tab
132 axial extent, tab
134 axial extent, groove
135 inner portion, resilient element
137 end, resilient element
138 outer portion, resilient element
139 end, resilient element
140 circumferentially continuous lip, outer ring
142 surface, sleeve
141 surface, outer ring
144 surface, circumferentially continuous lip
146 gap
148 distal end, tab
150 circumferentially discontinuous groove, outer ring
152 circumferentially discontinuous lip, outer ring
153 surface, outer ring
154 surface, circumferentially discontinuous lip
156 surface, outer ring
200 bearing assembly
202 housing
204 shaft
205 surface, housing

1. A bearing, comprising:
an inner ring defining a first groove;
an outer ring including a radially inner surface, the radially inner surface facing an axis of rotation of the bearing and defining:
a second groove; and,
at least one third groove;
a cage radially disposed between the inner ring and the outer ring;
a plurality of balk retained by the cage, and disposed in the first groove, and in the second groove;
an annular sleeve including a first portion disposed in the at least one third groove; and,
a resilient element urging the outer ring and the annular sleeve away from each other parallel to the axis of rotation of the bearing.

2. The bearing of claim 1, wherein:
the at least one third groove includes:
a circumferentially continuous groove; or,
a plurality of circumferentially oriented and circumferentially discontinuous grooves; and,
the first portion of the annular sleeve in des a plurality of radially outwardly extending tabs disposed in the at least one third groove.

3. The bearing of claim 1, wherein:
the first portion of the annular sleeve includes a radially outwardly extending tab disposed in the at least one third groove;
the radially outwardly extending tab has a maximum extent in an axial direction parallel to the axis of rotation;
the at least one third groove has a maximum extent in the axial direction; and,
the maximum extent of the at least one third groove is greater than the maximum extent of the radially outwardly extending tab.

4. The bearing of claim 1, wherein:
the first portion of the annular sleeve includes a radially outwardly extending tab disposed in the at least one third groove;
the radially outwardly extending tab has a maximum extent in an axial direction parallel to the axis of rotation;
the at least one third groove has a maximum extent in the axial direction; and,
the maximum extent of the at least one third groove is at least twice the maximum extent of the radially outwardly extending tab.

5. The bearing of claim 1, wherein:
the annular sleeve includes:
a second portion orthogonal to the axis of rotation; and,
a third portion extending from the second portion toward the plurality of balls; and,
the first portion of the annular sleeve extends radially outwardly from the third portion of the annular sleeve.

6. The bearing of claim 5, wherein the resilient element and the third portion of the annular sleeve define a gap in a direction orthogonal to the axis of rotation.

7. The bearing of claim 1, wherein:
the resilient element is circumferentially continuous; and,
the resilient element includes:
a radially inner portion in contact with the outer ring; and,
a radially outer portion in contact with the annular sleeve.

8. The bearing of claim 1, wherein:
the outer ring includes a circumferentially oriented lip;
the circumferentially oriented lip partly defines the at least one third groove;
the first portion of the annular sleeve includes a radially outwardly extending tab disposed in the at least one third groove; and,
the resilient element urges the circumferentially oriented lip and the radially outwardly extending tab toward each other.

9. The bearing of claim 1, wherein:
no portion of the annular sleeve is located radially outward of the outer ring; or,
no portion of the resilient element is located radially outward of the outer ring.

10. The bearing of claim 1, wherein the annular sleeve is circumferentially continuous.

11. A bearing, comprising:
an inner ring defining a first circumferentially continuous groove;
an outer ring including a radially inner surface, the radially inner surface:
defining a second circumferentially continuous groove; and,
defining at least one circumferentially oriented groove;
a cage radially disposed between the inner ring and the outer ring;
a plurality of balk retained by the cage, and disposed in the first circumferentially continuous groove, and in the second circumferentially continuous groove;
an annular sleeve including at least one radially outwardly extending tab the at least one radially outwardly extending tab including a distal end disposed in the at least one circumferentially oriented groove; and,
a resilient element:
in contact with the annular sleeve and the outer ring; and,
urging the outer ring and the annular sleeve away from each other parallel to an axis of rotation of the bearing, wherein a maximum extent of the at least one circumferentially oriented groove in an axial direction, parallel to the axis of rotation, is at least twice a maximum extent of the at least one radially outwardly extending tab in the axial direction.

12. The bearing of claim 11, wherein:
the outer ring includes at least one circumferentially oriented lip defining the at least one circumferentially oriented groove in the axial direction;
the at least one circumferentially oriented lip includes at least one radially inwardly facing surface; and,
the annular sleeve includes a radially outwardly facing surface in contact with the at least one radially inwardly facing surface.

13. The bearing of claim 11, wherein:
the annular sleeve includes a radially innermost portion;
the resilient element includes a radially innermost portion in contact with the outer ring; and,
the radially innermost portion of the resilient element and the radially innermost portion of the annular sleeve define a gap in a radial direction orthogonal to the axis of rotation.

14. The bearing of claim 11, wherein:
the outer ring includes at least one circumferentially oriented lip defining the at least one circumferentially oriented groove in the axial direction; and,
the resilient element urges the at least one radially outwardly extending tab and the at least one circumferentially oriented lip into contact.

15. The bearing of claim 11, wherein:
the outer ring includes at least one circumferentially oriented lip defining the at least one circumferentially oriented groove in the axial direction; and,
the at least one circumferentially oriented lip is axially disposed between the resilient element and the radially outwardly extending tab.

16. The bearing of claim 11, wherein:
the at least one circumferentially oriented groove includes a plurality of circumferentially discontinuous grooves; and,
the at least one radially outwardly extending tab includes a plurality of radially outwardly extending tabs disposed in the plurality of circumferentially discontinuous grooves,

17. A method of preloading a bearing assembly, the bearing assembly including a housing, a bearing enclosed by the housing, the bearing including an inner ring defining a first groove, an outer ring connected to the housing and including a radially inner surface defining a second groove and a circumferentially oriented groove, a cage radially disposed between the inner ring and the outer ring, a plurality of balk retained by the cage and disposed in the first groove and in the second groove, a ring-shaped sleeve with a tab disposed in the circumferentially oriented groove, and a resilient element in contact with the ring-shaped sleeve and the outer ring, and a shalt connected to the inner ring, the method comprising:
urging, with the resilient element, the ring-shaped sleeve into contact with a surface of the housing facing in a first axial direction parallel to an axis of rotation of the bearing;
urging, with the resilient element and with a first force, the outer ring in the first axial direction, with respect to the housing, and into contact with the plurality of balls;
rotating the shaft and the inner ring, with respect to the housing, in a circumferential direction around the axis of rotation of the bearing; and,
displacing, with a second force, less than the first force, the outer ring in the first axial direction, maintaining, with the resilient element, a contact of the ring-shaped sleeve with the surface of the housing, and maintaining with the resilient element, a contact of the outer ring with the plurality of balls; or,
displacing, with a second force, less than the first force, the outer ring in a second axial direction opposite the first axial direction, maintaining, with the resilient element, a contact of the ring-shaped sleeve with the surface of the housing, and maintaining, with the resilient element, a contact of the outer ring with the plurality of balls.

18. The method of claim 17, wherein displacing, with the second force, the outer ring in the second axial direction includes less than fully compressing the resilient element,

19. The method of claim 17, wherein displacing, with the second force, the outer ring in the first axial direction includes:
fully expanding the resilient element; and,
avoiding contact of the tab with a surface of the outer ring defining the circumferentially oriented groove in the first axial direction.

20. The method of claim 17, wherein rotating the shaft and the inner ring, with respect to the housing, in the circumferential direction includes maintaining contact of a radially outwardly facing surface of the ring-shaped sleeve with a radially inwardly facing surface of a lip of the outer ring defining the circumferentially oriented groove in a second axial direction, opposite the first axial direction.
